(19) United States
(12) Patent Application Publication
(10) Pub. No.: US 2012/0328869 A1
(43) Pub. Date: Dec. 27, 2012

(54) SOLAR CELL BACKSHEET

(75) Inventors: Yusuke Akasaki, Kanagawa (JP); Shinji Tanaka, Kanagawa (JP)

(73) Assignee: FUJIFILM Corporation, Tokyo (JP)

(21) Appl. No.: 13/582,895

(22) PCT Filed: Mar. 24, 2011
(86) PCT No.: PCT/JP2011/058152

§ 371 Date: Sep. 5, 2012

(30) Foreign Application Priority Data
Mar. 25, 2010 (JP) 2010-070589
Feb. 24, 2011 (JP) 2011-038854

(51) Int. Cl. C09J 7/02

(52) U.S. Cl. 428/328; 428/343; 428/323; 428/356; 428/355 R; 428/355 EN; 428/355 AC; 428/331; 428/330

(57) ABSTRACT

A solar cell backsheet is disposed to contact a sealing material on a cell side of a substrate at which solar cell elements are sealed with the sealing material, and includes a support that satisfies Equation (1) and an adhesive layer including a binder and inorganic fine particles in an amount of from 50% to 200% by volume of the total volume of the binder, peeling strength between the sealing material and the adhesive layer being 10 N/20 mm or more after the solar cell backsheet is stored in an 85° C. and 85% RH atmosphere for 1,000 hours. Equation (1): 1.0≧(ELBA)/(ELBB)≧0.5 (ELBA and ELBB respectively denote elongation at break after and before 50 hours of storage in a 120° C. and 100% RH atmosphere.) The backsheet has excellent adhesion to a sealing material in a wet and hot environment.

### BACKGROUND OF THE INVENTION

1. Technical Field

The present invention relates to a backsheet for a solar cell.

2. Background Art

Solar cells are electricity generating systems that discharge no carbon dioxide on electric power generation and have a small burden on the environment. Solar cells have been spreading rapidly in recent years.

A solar cell module has a structure in which solar cells are sandwiched between front face glass on a sunlight incident side and a so-called backsheet that is placed on the opposite side (rear side) to the sunlight incident side. A space between the front face glass and the solar cells and a space between the solar cells and the backsheet are sealed respectively with an EVA (ethylene-vinylacetate copolymer) resin or the like.

The backsheet has a function of preventing water penetration from the rear face of a solar cell module. Conventionally, the backsheet has been made of glass and the like. In recent years, in view of costs, resins such as polymer have come to be used. The backsheet is not merely a polymer sheet, and is also required to have a property of bonding firmly to a sealing material.

Regarding this point, disposing a readily-adhesive layer on the topmost surface of the backsheet is known. For instance, a technique of applying a film-curing agent or disposing a heat bonding layer on a polyester support has been disclosed (see, Japanese Patent Application Laid-Open (JP-A) Nos. 2006-152013 and 2003-060218, for instance).

### SUMMARY OF THE INVENTION

According to an aspect of the invention, a solar cell backsheet is disposed to contact a sealing material on a cell side of a substrate at which solar cell elements are sealed with the sealing material, the backsheet including: a support that satisfies a relationship represented by the following Equation (1); and a readily-adhesive layer including a binder and inorganic fine particles, an amount of the inorganic fine particles being from 50% by volume to 200% by volume with respect to the total volume of the binder and peeling strength between the sealing material and the readily-adhesive layer exhibiting a value of 10 N/20 mm or more after the solar cell backsheet is stored in an atmosphere of 85° C. and 85% RH for 1,000 hours, which is excellent in term of adhesion to a sealing material in a wet and heat environment, is provided.

1.0≧(ELBA)/(ELBB)>0.5 Equation (1)

In Equation (1), the abbreviation ELBA denotes elongation at break after 50 hours of storage in an atmosphere of 120° C. and 100% RH, and the abbreviation ELBB denotes elongation at break before 50 hours of storage in an atmosphere of 120° C. and 100% RH.

### Technical Problem

The techniques described in JP-A Nos. 2006-152013 and 2003-060218 are intended to improve adhesion between the sealing material and the backsheet. However, the adhesion is not sufficient in wet and hot conditions. Further, adhesion between the support and the respective other layers is also needed.

The present invention has been accomplished in view of the above circumstances, and it is a purpose of the present invention to achieve the following objectives. Namely, it is a purpose of the present invention to provide a solar cell backsheet that exhibits excellent adhesion to a sealing material even in a wet and hot environment.

### Solution to Problem

Exemplary embodiments of the present invention include the following.

<1> A backsheet for a solar cell, the backsheet being disposed to contact a sealing material on a cell side of a substrate at which solar cell elements are sealed with the sealing material, the backsheet including, a support that satisfies a relationship represented by the following Equation (1); and an readily-adhesive layer including a binder and inorganic fine particles, an amount of the inorganic fine particles being from 50% by volume to 200% by volume with respect to the total volume of the binder, peeling strength between the sealing material and the readily-adhesive layer exhibiting a value of 10 N/20 mm or more after the solar cell backsheet is stored in an atmosphere of 85° C. and 85% RH for 1,000 hours;

1.0≧(ELBA)/(ELBB)≧0.5 Equation (1)

wherein, in Equation (1), an abbreviation of ELBA denotes an elongation at break after 50 hours of storage in an atmosphere of 120° C. and 100% RH, and an abbreviation of ELBB denotes an elongation at break before 50 hours of storage in an atmosphere of 120° C. and 100% RH.

<2> The backsheet for a solar cell according to the item <1>, wherein the amount of the inorganic fine particles is from 75% by volume to 180% by volume with respect to the total volume of the binder.

<3> The backsheet for a solar cell according to the item <1>or the item <2>, wherein the volume average particle diameter of the inorganic fine particles is in a range of from 0.02 μm to 2.00 μm.

<4> The backsheet for a solar cell according to any one of the items <1>to <3>, wherein the inorganic fine particles include at least one selected from the group consisting of silica, calcium carbonate, magnesium oxide, magnesium carbonate and tin oxide.

<5> The backsheet for a solar cell according to any one of the items <1>to <4>, wherein the support includes polyester.

<6> The backsheet for a solar cell according to the item <5>, wherein the polyester is polyethylene terephthalate.

<7> The backsheet for a solar cell according to the item <5>or the item <6>, wherein a content of a carboxyl group in the polyester is 35 equivalents per ton or less.

<8> The backsheet for a solar cell according to any one of the items <5>to <7>, wherein the content of a carboxyl group in the polyester is in a range of 2 equivalents per ton to 35 equivalents per ton.

<9> The backsheet for a solar cell according to any one of the items <1>to <8>, wherein the binder includes at least one selected from the group consisting of polyolefin, polyester and (meth)acrylic based polymer.

<10> The backsheet for a solar cell according to any one of the items <1>to <9>, wherein the sealing material includes an ethylene-vinylacetate copolymer-based polymer.

<11> The backsheet for a solar cell according to any one of the items <1>to <10>, wherein the binder includes a crosslinked structure.

<12> The backsheet for a solar cell according to the item <11>, wherein the crosslinked structure is formed using an oxazoline-based cross-linking agent.

<13> The backsheet for a solar cell according to any one of the items <1>to <12>, having a surface electrical resistance of from 8.5 to 12.

### DESCRIPTION OF EMBODIMENTS

Solar Cell Backsheet

A solar cell backsheet of the present invention is disposed in a manner that the solar cell backsheet contacts a sealing material on a cell side of a substrate at which solar cell elements are sealed with the sealing material. The solar cell backsheet is composed of a support that satisfies the following equation (1) and an readily-adhesive layer that includes therein a binder and inorganic fine particles; the amount of the inorganic fine particles is from 50% by volume to 200% by volume with respect to the total volume of the binder; and peeling strength between the sealing material and the readily-adhesive layer exhibits a value of 10 N/20 mm or more after the solar cell backsheet is stored in an atmosphere of 85° C. and 85% RH for 1,000 hours.

1.0≧(ELBA)/(ELBB)≧0.5 Equation (1)

In Equation (1), the abbreviation ELBA denotes an elongation at break after 50 hours of storage in an atmosphere of 120° C. and 100% RH, and the abbreviation ELBB denotes an elongation at break before 50 hours of storage in an atmosphere of 120° C. and 100% RH.

In the present invention, a solar cell backsheet that is configured as described above exhibits excellent adhesion between the sealing material and the readily-adhesive layer. Particularly, adhesion between the sealing material and the readily-adhesive layer is excellent not only in an atmosphere of normal temperature and normal pressure (20° C. and 30%RH, for instance) but also after 1,000 hours of storage in a wet and heat atmosphere of 85° C. and 85% RH. Namely, peeling strength between the sealing material and the readily-adhesive layer is 10 N/20 mm or more.

The reason why the solar cell backsheet of the present invention exhibits the above bonding performance is not clear, but the reason may be speculated as follows.

Note that, a wet and heat storage treatment of leaving a support in an atmosphere of 120° C. and 100% RH for 50 hours is also referred to as “wet and heat storage treatment 1.” Further, a wet and heat storage treatment of leaving a solar cell backsheet in an atmosphere of 85° C. and 85% RH for 1,000 hours is also referred to as “wet and heat storage treatment 2.”

Furthermore, the solar cell backsheet is sometimes referred to as simply “backsheet.”

Furthermore, the readily-adhesive layer is sometimes referred to as simply “adhesive layer.”

The surface of the readily-adhesive layer may be provided with an anchor effect by incorporating the binder and the inorganic fine particles in the readily-adhesive layer that contacts the sealing material; the amount of the inorganic fine particles is from 50% by volume to 200% by volume with respect to the total volume of the binder, whereby adhesion to the sealing material is considered to be increased.

Adhesion between the sealing material and the backsheet is considered to attribute to relative strength at two interfaces, namely, an interface between the support of the backsheet and the readily-adhesive layer of the backsheet and an interface between the readily-adhesive layer of the backsheet and the sealing material. In order to strengthen the adhesion between the sealing material and the backsheet, it is desirable that adhesion is increased at both interfaces, but, in particular, it has been found that prevention of peeling off at the interface between the support of the backsheet and the readily-adhesive layer of the backsheet is effective. Therefore, when the readily-adhesive layer is composed of two or more layers, conditioning of the binder and inorganic fine particles that are included in an readily-adhesive layer disposed close to the support, desirably adjacent to the support, is considered to be advantageous.

Here, the elongation at break of the support denotes an elongation of the support at the time when the support is stretched in the longitudinal direction thereof and broken.

Even a support that exhibits sufficient strength and flexibility at normal temperature and normal pressure (20° C. and 30% RH, for instance), the support is generally degraded and becomes brittle in a wet and heat atmosphere of 120° C. and 100% RH, wherein strength and flexibility are easily lowered. In the present invention, a support that supports an readily-adhesive layer exhibits such a durability that the elongation at break is not easily lowered even after a wet and heat storage treatment (wet and heat treatment 1) of leaving the support in a wet and heat atmosphere of 120° C. and 100% RH for 50 hours.

In this way, the solar cell backsheet of the present invention includes therein: a support that exhibits durability even in a wet and heat environment such as the wet and heat storage treatment 1; and an readily-adhesive layer that possesses the anchor effect, so that adhesion between the sealing material and the readily-adhesive layer is considered to be increased.

Furthermore, in the solar cell backsheet of the present invention, inorganic fine particles (filler) having low conductivity are used, so that surface electrical resistance of the backsheet may be increased, whereby the backsheet is considered to exhibit excellent electrical insulation properties.

Hereinafter, respective members that compose the solar cell backsheet of the present invention will be described in detail.

Support

The support is not particularly limited and may be glass or polymer as long as it satisfies the following equation (1).

1.0≧(ELBA)/(ELBB)≧0.5 Equation (1)

In Equation (1), the abbreviation ELBA denotes an elongation at break after 50 hours of storage in an atmosphere of 120° C. and 100% RH, and the abbreviation ELBB denotes an elongation at break before 50 hours of storage in an atmosphere of 120° C. and 100% RH.

In Equation (1), “elongation at break” denotes, as already described, an elongation at the time when a support is stretched in the longitudinal direction thereof and is broken. More specifically, “elongation at break” denotes an elongation at the time when a support, a plate 10 mm wide and 200 mm long, is stretched in the longitudinal direction thereof at strength of 20 mm/minute and is broken.

For the sake of simplicity, the following expression (equation (2)) is used.

RRE=(ELBA)/(ELBB) Equation (2)

In Equation (2), the abbreviation ELBA denotes an elongation at break after 50 hours of storage in an atmosphere of 120° C. and 100% RH, the abbreviation ELBB denotes an elongation at break before 50 hours of storage in an atmosphere of 120° C. and 100% RH, and the abbreviation RRE denotes a retention ratio of elongation at break.

A retention ratio of elongation at break (RRE) of 1.0 means that a support after the wet and heat storage treatment 1 is capable of providing the same elongation as a support before the wet and heat treatment 1 provides on stretching. A retention ratio of elongation at break of 0.5 means that a support after the wet and heat storage treatment 1 is capable of providing half of elongation that a support before the wet and heat storage treatment 1 provides on stretching. When the retention ratio of elongation at break is selected to be from 0.5 to 1.0, a support that exhibits durability of keeping bonding to the readily-adhesive layer in a wet and heat environment such as the wet and heat storage treatment 1 may be attained.

The retention ratio of elongation at break is preferably from 0.8 to 1.0.

A support in embodiments of the invention is preferably made with polymer from viewpoint that retention rate of fracture elongation of the sheet be set in a range described above.

Examples of the polymer include polyester; polyolefin such as polypropylene, polyethylene; fluorocarbon based polymer such as polyvinyl fluoride; and the like. Among above, polyester is preferable from viewpoints of cost, mechanical strength and the like. Hereafter, a support formed with polyester may also refer as a polyester base material in some cases.

Further, the polyester is preferably saturated linear polyester synthesized by a reaction of an aromatic dibasic acid or an ester formable derivative thereof with a diol or an ester formable derivative thereof Examples of the polyester include polyethylene terephthalate, polyethylene isophthalate, polybutylene terephthalate, poly 1,4-cyclohexylenedimethylene terephthalate, polyethylene 2,6-naphthalate and the like. Among them, polyethylene terephthalate or polyethylene 2,6-naphthalate is preferable, and polyethylene terephthalate is more preferable from viewpoint of a balance of mechanical strength, cost and the like.

The polyester may be a homo-polymer or a co-polymer. In addition, the polyester may be blended with a small amount of the other kinds of reins such as polyimide.

When the polyester in the present invention is polymerized, from the viewpoint of suppressing the amount of carboxyl group within a predetermined range, a compound of Sb-based, Ge-based, or Ti-based is preferably used as a catalyst. Among these, a Ti-based compound is particularly preferable. When the Ti-based compound is used, in a preferred embodiment, polymerization is performed by using the Ti-based compound as a catalyst in an amount of from 1 ppm to 30 ppm and more preferably from 3 ppm to 15 ppm. When the amount of the Ti-based compound is in the above range, end carboxyl group may be adjusted within a range described later, and hydrolysis resistance of the polymer base material may be maintained low.

Polyester synthesis using the titanium-based compound may be performed by applying a method described in Japanese published examined application patent No. 8-301,198, Japanese patent Nos. 2,543,624, 3,335,683, 3,717,380, 3,897,756, 3,962,226, 3,979,866, 3,996,871, 4,000,867, 4,053,837, 4,127,119, 4,134,710, 4,159,154, 4,269,704, 4,313,538, and the like.

The content of carboxyl group in the polyester is preferably 50 eq. (equivalent)/t or less and more preferably 35 eq./t or less. When the content of carboxyl group is 50 eq./t or less, hydrolysis resistance may be maintained unchanged and lowering in the strength after storage under a wet and heat condition may be suppressed small. The lower limit of the content of carboxyl group is 2 eq./t desirably, from the viewpoint of retention of adhesion between the support and an adjacent layer to the support (for instance, an readily-adhesive layer).

The content of carboxyl group in the polyester may be adjusted by selecting the kind of the catalyst and film forming conditions (film forming temperature or time).

The polyester in the present invention is preferably subjected to solid phase polymerization after polymerization. By means of this, a preferable content of carboxyl group may be attained. Solid phase polymerization may be performed in a continuous process (a process in which a tower is filled with resins; the resins are made to stagnate slowly for a predetermined time while heated; and then the resins are fed out), or a batch-wise process (a process in which resins are loaded in a container, and then heated for a predetermined time). Specifically, a synthetic method described in Japanese patent Nos. 2,621,563, 3,121,876, 3,136,774, 3,603,585, 3,616,522, 3,617,340, 3,680,523, 3,717,392, 4,167,159, and the like, is applicable to the solid phase polymerization of polyester.

The solid phase polymerization of the polyester is preferably performed at a temperature in a range of from 170° C. or higher and 240° C. or lower, more preferably in a range of from 180° C. or higher and 230° C. or lower, and even more preferably in a range of from 190° C. or higher and 220° C. or lower. The solid phase polymerization of the polyester is preferably performed in a vacuum or under nitrogen gas atmosphere.

The polyester base material in the present invention is preferably a biaxially stretched film, which is stretched for instance as: the above polyester is fused and extruded into a film-form; the film-form polyester is cooled and solidified with a casting drum into a non-stretched film; the non-stretched film is stretched in a longitudinal direction at a temperature of from Tg to (Tg+60)° C. one time or two or more times in a manner that total stretch becomes from 3 times to 6 times; and then the film is further stretched in a transverse direction at a temperature of from Tg to (Tg+60)° C. in a manner that total stretch becomes from 3 times to 5 times.

The polyester base material may be further subjected to heat treatment for from 1 sec to 60 sec at a temperature of from 180° C. to 230° C., if necessary.

The thickness of the support (particularly, polyester base material) is preferably from 25 μm to 300 μm or from about 25 μm to about 300 μm. A thickness of 25 μm or more provides adequate mechanical strength. A thickness of 300 μm or less is advantageous in cost.

Particularly, the polyester base material tends to become lowered in hydrolysis resistance as the thickness thereof increases and become not tolerable for long-time service. In the present invention, preferably, the thickness is from 120 μm to 300 μm and the content of carboxyl group in the polyester is from 2 equivalents per ton to 35 equivalents per ton, whereby an effect of improving wet and heat durability may be exerted much more. The content of carboxyl group in the polyester of the polyester base material contributes bonding between a support and a coating layer, so that the content is more preferably 10 equivalents per ton or more, considering comprehensively wet and heat durability and bonding strength.

Readily-Adhesive Layer

An readily-adhesive layer in the present invention is configured as: a binder and inorganic fine particles are included therein; and the amount of the inorganic fine particles is from 10% by volume to 500% by volume with respect to the total volume of the binder. The readily-adhesive layer may further include the other components such as additives if necessary.

The readily-adhesive layer serves to bond firmly the backsheet to a sealing material. The sealing material seals solar cell elements (hereinafter, also referred to as “power generation elements”) that are a main body of the cell. Specifically, the readily-adhesive layer of the present invention is disposed in a manner that peeling strength against the sealing material exhibits a value of 10 N/20 mm or more and preferably 50 N/20 mm or more after 1,000 hours of storage in an atmosphere of 85° C. and 85% RH (wet and heat storage treatment 2).

The wet and heat condition of the wet and heat storage treatment 2 is considerably hard as compared with usual environment in which the solar cell backsheets are used, but it is an accelerated condition for evaluating long time reliability of the backsheet.

When the peeling strength against the sealing material after treated under the wet and heat storage treatment 2 is less than 25 N/20 mm, wet and heat resistance required for maintaining adhesion is not sufficient and peeling occurs with time, whereby a solar cell module with an excellent long-time durability is not attained. The above mentioned peeling strength may be provided by a method of regulating the amount of the inorganic fine particles with respect to the binder in the readily-adhesive layer, or by the other methods. The other methods includes a method of applying a corona discharge treatment on a backsheet face to which the sealing material is bonded.

For the sealing material that seals solar cell elements, a sealing material based on ethylene-vinylacetate copolymer-based polymer (EVA; ethylene-vinylacetate copolymer) is preferably used, from viewpoints of flexibility and weather resistance.

The peeling strength between the readily-adhesive layer and the sealing material is represented by a value that is measured with “TENSILON” (trade name) (RTC-1210A, manufactured by ORIENTEC Co., Ltd.) under conditions of peeling angle of 180° and rate of pulling of 300 mm/minute.

When an EVA sealing material is used as the sealing material, measurement of the peeling strength may be performed specifically as follows.

A backsheet having an readily-adhesive layer formed on a support is cut into 20 mm wide×150 mm long, so that two sheets are prepared. In addition, an EVA sheet [EVA sheet: “SC50B” (trade name), manufactured by Mitsui Chemicals Fabro, Inc.] that is cut into 20 mm wide×100 mm long is prepared. Thus prepared EVA sheet is sandwiched between the two backsheets in a manner that respective readily-adhesive layers face to the inside, and then they are bonded together by hot-pressing with a vacuum laminator (vacuum lamination machine, manufactured by Nisshinbo Industries, Inc.). In this way, the readily-adhesive layers and the EVA sealing material are bonded together. The condition for bonding the readily-adhesive layers and the EVA sealing material may be, as described below, a one-time bonding or a two-time bonding.
One-time bonding: bonding at 150° C. for 30 minutes (with a vacuum laminator), and
Two-time bonding: temporary bonding (with a vacuum laminator) is performed by 2 minute pressing after 3 minute vacuum suction at 128° C.; then, using a dry oven, full bonding is performed at 150° C. for 30 minutes.

Inorganic Fine Particles

The readily-adhesive layer includes at least one kind of inorganic fine particles therein.

Examples of the inorganic fine particles include: silica; calcium carbonate; magnesium oxide; magnesium carbonate; and tin oxide. Among these, fine particles of tin oxide or silica are preferable from a viewpoint that adhesion is less degraded in a wet and heat atmosphere.

The particle size of the inorganic fine particles is preferably from 10 nm to 700 nm or about from 10 nm to about 700 nm in terms of volume average particle size, more preferably from 20 nm to 300 nm or from about 20 nm to about 300 nm. When the particle size is in this range, a more adequate readily-adhesive layer may be obtained. The particle size is represented by a value that is measured with a laser diffraction particle size distribution analyzer “LA950” [trade name, manufactured by HORIBA, Ltd.]

The shape of the inorganic fine particles is not particularly limited, but any shape including spherical, amorphous, and needle-like may be used.

The content of the inorganic fine particles is in a range of from 50% by volume to 200% by volume with respect to the total volume of the binder in the readily-adhesive layer. When the content of the inorganic fine particles is less than 50% by volume, adequate adhesion may not be secured in a wet and heat atmosphere. A content of the inorganic fine particles of over 200% by volume makes the face condition of the readily-adhesive layer degraded.

In particular, the content of the inorganic fine particles is preferably in a range of from 75% by volume to 180% by volume.

Binder

The readily-adhesive layer includes at least one kind of binder therein.

Examples of the binder suitable for the readily-adhesive layer include: polyolefin; polyester; acrylic polymer; and polyurethane. Among these, polyolefin, polyester, and acrylic polymer are preferable from the viewpoint of durability. Acrylic resin and polyolefin are more preferable. In addition, as the acrylic resin, a composite resin of acrylic polymer and silicone is also preferable.

Examples of a preferable binder include: “CHEMIPEARL S-120” and “CHEMIPEARL S-75N” (trade names: both are manufactured by Mitsui Chemicals, Inc.), which are specific examples of the polyolefin; “JURYMER ET-410” and “JURYMER SEK-301” (trade names: both are manufactured by Nihon Junyaku Co., Ltd.), which are specific examples of the acrylic resin; and “CERANATE WSA1060” and “SERANATE WSA1070” (trade names: both are manufactured by DIC Corp.) and “H7620”, “H7630”, and “H7650” (trade names: all of them are manufactured by ASAHI KASEI CHEMICALS CORP.), which are specific examples of the composite resin of acrylic polymer and silicone.

The amount of the binder contained in the readily-adhesive layer is in a range of from 0.05 g/m² to 5 g/m². Particularly, a range of from 0.08 g/m² to 3 g/m² is preferable. When the amount of the binder contained in the readily-adhesive layer is less than 0.05 g/m², a desired adhesion is not obtained. An amount of over 5 g/m² of the binder contained in the readily-adhesive layer may not provide adequate face condition.

Additives

To the readily-adhesive layer of the present invention, a known matte agent such as polystyrene or polymethyl methacrylate, and a known surfactant such as an anionic or a nonionic may be further added if necessary.

Method of Forming Readily-Adhesive Layer

Examples of a method of forming the readily-adhesive layer include: a method in which a polymer sheet that includes therein a binder and inorganic fine particles in an amount already described is bonded to a support; and a method in which a coating liquid (coating liquid for readily-adhesive layer) that includes therein a binder and inorganic fine particles in an amount already described is applied. Among these, the method in which the coating liquid is applied is preferable from the viewpoint of obtaining a uniform and thin film.

As the coating method, a known method such as gravure coating or bar coating may be used.

A coating solvent that is used for preparation of the coating liquid may be water or an organic solvent such as toluene or methyl ethyl ketone. The coating solvent may be used in a manner of one kind alone or two or more kinds in a mixture.

Regarding the readily-adhesive layer, the binder that is included in the readily-adhesive layer preferably has a cross-linking structure from the viewpoint of improving strength. An readily-adhesive layer that includes therein a binder having a cross-linking structure may be obtained not only by bonding a polymer sheet that includes inorganic fine particles and a binder having a cross-linking structure to a support, but also by using a coating liquid for readily-adhesive layer that includes therein additionally a cross-linking agent. The coating liquid for readily-adhesive layer that includes a cross-linking agent is applied and dried on a support, so that the readily-adhesive layer that includes a binder having a cross-linking structure may be prepared.

Cross-Linking Agent

Examples of a cross-linking agent suitable for cross-linking the binder included in the readily-adhesive layer include: a cross-linking agent of epoxy-based; isocyanate-based; melamine-based; carbodiimide-based; and oxazoline-based. Among these, the oxazoline-based cross-linking agent is particularly preferable, from the viewpoint of securing adhesion after a wet and heat period. Therefore, it is preferable that the binder in the readily-adhesive layer includes a cross-linked structure formed by a reaction of the oxazoline-based cross-linking agent with a binder polymer.

Examples of the oxazoline-based crosslinking agents include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-ethyl-2-oxazoline, 2,2′-bis(2-oxazoline), 2,2′-methylene-bis(2-oxazoline), 2,2′-ethylene-bis(2-oxazoline), 2,2′-trimethylene-bis(2-oxazoline), 2,2′-tetramethylene-bis(2-oxazoline), 2,2′-hexamethylene-bis(2-oxazoline), 2,2′-octamethylene-bis(2-oxazoline), 2,2′-ethylene-bis(4,4′-dimethyl-2-oxazoline), 2,2′-p-phenylene-bis(2-oxazoline), 2,2′-m-phenylene-bis(2-oxazoline), 2,2′-m-phenylene-bis(4,4′-dimethyl-2-oxazoline), bis(2-oxazolinylcyclohexane)sulfide, bis(2-oxazolinylnorbornane)sulfide, and the like. Further, (co)polymer of these compounds may be preferably used. Furthermore, EPOCROS K 2010E, EPOCROS K 2020E, EPOCROS WS-500, EPOCROS WS-700 (trade name, all manufactured by NIPPON SHOKUBAI CO., LTD.) are also usable as the compound containing an oxazoline group.

The amount of the cross-linking agent in the coating liquid for readily-adhesive layer is preferably from 5% by mass to 50% by mass with respect to the total mass of the binder that is included in the coating liquid for readily-adhesive layer, and more preferably from 20% by mass to 40% by mass. When the amount of the cross-linking agent is 5% by mass or more, adequate cross-linking effect is obtained, whereby strength and adhesion of a color layer may be secured. An amount of the cross-linking agent of 50% by mass or less may render the pot-life of the coating liquid longer.

The thickness of the readily-adhesive layer is not particularly limited, but usually preferably from 0.05 μm to 8 μm and more preferably from 0.1 μm to 5 μm. When the thickness of the readily-adhesive layer is 0.05 μm or more, required performance of readily-adhesive may be obtained in a suitable way. A thickness of the readily-adhesive layer of 8 μm or less provides more adequate face condition.

Note that, the readily-adhesive layer may be only a single layer or two or more layers. When the readily-adhesive layer works also as a layer reflecting sun light (color layer) which is described later, an readily-adhesive layer that works as the color layer is formed desirably at the top of two or more readily-adhesive layers; here, the side that faces to a support is positioned at the bottom of the layers. When the readily-adhesive layers are laminated together while the readily-adhesive layer that works as a color layer is not positioned at the top thereof, a layer positioned on the upper side of the readily-adhesive layer that works as a color layer is required to be transparent so as not to lower the effect of the readily-adhesive layer that works as a color layer.

Undercoat Layer

In the solar cell backsheet according to the present invention, an undercoat layer may be disposed between the support and the readily-adhesive layer. The thickness of the undercoat layer is in a range of preferably 2 μm or less, more preferably from 0.05 μm to 2 μm, and even more preferably from 0.1 μm to 1.5 μm. When the thickness of the undercoat layer is 2 μm or less, face condition may be kept properly. When the thickness of the undercoat layer is 0.05 μm or more, necessary adhesiveness is easily achieved.

The undercoat layer may include a binder therein. As the binder, for instance, polyester, polyurethane, acrylic resin, polyolefin, and the like may be used. In addition, to the undercoat layer, besides the binder, a cross-linking agent of epoxy-based, isocyanate-based, melamine-based, carbodiimide-based, oxazoline-based or the like, a surfactant such as anionic or nonionic, or filler such as silica may be added.

There is not any particular limitation on a method of applying the undercoat layer and on a solvent of the coating liquid that is used therein.

As a coating method, a gravure coater or a bar coater may be used.

The solvent used for the coating liquid may be water or an organic solvent such as toluene or methyl ethyl ketone. The solvent may be used in a manner of one kind alone or two or more kinds in a mixture.

Furthermore, application may be performed onto a polymer base material that has been biaxially stretched. In another method, application may be performed onto a polymer base material that has been uniaxially stretched, and then the polymer base material may be further stretched in a direction different from the uniaxial direction. In still another method, application may be performed onto a base material before being stretched, and then the base material may be stretched in two directions.

Color Layer

The solar cell backsheet of the present invention may include a color layer therein.

The color layer in the present invention may include a pigment and a binder therein, and further include the other components such as various kinds of additives.

A first function of the color layer is to increase power generation efficiency of a solar cell module by way of returning back to solar cells part of incident light that passes through solar cells and reaches the backsheet without being used for power generation. A second function thereof is to improve decorative appearance of the solar cell module seen from the sun light incident side (front face side). Usually, when a solar cell module is seen from the front face side, a backsheet is seen around solar cells. By providing the backsheet with a color layer, the decorative character is enhanced, whereby the appearance may be improved.

Pigment

As a pigment in the color layer, for instance, an inorganic pigment such as titanium oxide, barium sulfate, silicon oxide, aluminum oxide, magnesium oxide, calcium carbonate, kaolin, talc, ultramarine blue pigment, deep blue pigment or carbon black, and an organic pigment such as phthalocyanine blue or phthalocyanine green may be selected appropriately and included.

The color layer includes therein the pigment in an amount of preferably from 2.5 g/m² to 8.5 g/m². When the amount of the pigment in the color layer is 2.5 g/m² or more, coloring is easily provided and the reflectance and decorative character are easily developed. When the amount of the pigment in the color layer is 8.5 g/m² or less, the face condition of the color layer is not easily degraded and the film strength is also not easily lowered.

In particular, the amount of the pigment in the color layer is more preferably in a range of from 4.5 g/m² to 8.0 g/m².

The average particle size of the pigment particles is preferably from 0.03 μm to 0.8 gm in terms of volume average particle size, and more preferably from 0.15 μm to 0.5 μm or from about 0.15 μm to about 0.5 μm. When the average particle size is in the above range, light reflectance is high. The average particle size is represented by a value that is measured with a laser diffraction particles size distribution analyzer “LA-950” (trade name, manufactured by HORIBA, Ltd.).

Binder

Examples of the binder in the color layer include: polyester; polyurethane; acrylic resin; and polyolefin. From the viewpoint of durability, acrylic resin and polyolefin are preferable. Specifically, the commercially available products already listed as the binder that is included in the readily-adhesive layer may be used.

The amount of the binder in the color layer is preferably in a range of from 15% by mass to 200% by mass with respect to the total mass of pigments included in the color layer, and more preferably in a range of from 17% by mass to 100% by mass. When the amount of the binder in the color layer is 15% by mass or more, the color layer is provided with sufficient strength. When the amount of the binder in the color layer is 200% by mass or less, the reflectance and decorative character of the color layer may be properly provided.

—Additives—

Additives such as surfactant, filler (inorganic fine particles), and the like other than binder and pigments may be added in the colored layer.

Examples of the surfactant include known surfactants such as anionic or nonionic ones. When the surfactant is added in the colored layer, the addition amount thereof is preferably from 0.1 mg/m² to 15 mg/m² and more preferably from 0.5 mg/m² to 5 mg/m². When the addition amount of the surfactant in the colored layer is 0.1 mg/m² or more, adequate formation of layers may be attained while repelling is prevented from being generated. In the case in which the addition amount of the surfactant in the colored layer is 15 mg/m² or less, proper adhesions may be performed.

In the color layer in the present invention, besides the above pigments, filler such as silica may be added. When the filler is added in the colored layer, the addition amount thereof is preferably 20% by mass or less with respect to the binder included in the color layer, and more preferably 15% by mass or less. When the addition amount of the filler in the colored layer is 20% by mass or less, required reflectance and decorative character in the colored layer may be obtained while the ratio of the pigments is not lowered.

Method of Forming Color Layer

The color layer may be formed by the following methods or others, including: a method in which a polymer sheet that includes a pigment is bonded to a support (bonding method); a method in which the color layer is co-extruded when a base material is formed (co-extrusion method); and a method in which a coating liquid for color layer is applied (coating method). Specifically, the color layer may be formed by the bonding method, the co-extrusion method, or the coating method coating directly onto the surface of the polyester base material or through an undercoat layer having a thickness of 2 μm or less. Thus formed color layer may be in a state of directly contacting the surface of the support or in a state of being laminated through the undercoat layer.

Among the above methods, the method in which the coating liquid is applied is desirable from the viewpoint that the method is not only simple but also allowed to form a uniform thin film.

In the case of coating, a known coating method such as gravure coating or bar coating may be used as the coating method.

The coating liquid for color layer may be a water-based one that uses water as a coating solvent or a solvent-based one that uses an organic solvent such as toluene or methyl ethyl ketone. Among these, from the viewpoint of environmental burden, water is preferably used as the solvent. The coating solvent may be used in a manner of one kind alone or two or more kinds in a mixture.

The binder included in the color layer may have a cross-linking structure. A color layer that includes a binder having a cross-linking structure may be formed by applying a coating liquid for color layer that includes therein a cross-linking agent on a support or the like, for instance. As the cross-linking agent, as the cross-linking agent, a cross-linking agent that has been listed as a suitable cross-linking agent for cross-linking the binder in the readily-adhesive layer may be suitably used.

The addition amount of the cross-linking agent is, with respect to the total mass of the binder included in the coating liquid for color layer, preferably from 5% by mass to 50% by mass and more preferably from 10% by mass to 40% by mass. When the addition amount of the cross-linking agent is 5% by mass or more, sufficient effect of cross-linking may be obtained while the strength and adhesion of the color layer are secured. When the addition amount of the cross-linking agent is 50% by mass or less, the pot life of the coating liquid may be exhibited longer.

Properties of Backsheet

The solar cell backsheet of the present invention has a surface electrical resistance of from 8.5 to 12. When the surface electrical resistance is 8.5 or more, electrical insulation properties of the backsheet are easily exhibited. Note that, the electrical insulation properties of the backsheet may be verified by the surface electrical resistance of the backsheet.

The surface electrical resistance of the backsheet is represented by a value (log SR) that is measured in accordance with resistivity as defined in JIS-K6911-1979. The measurement of the surface electrical resistance is performed on a backsheet that includes a support and an readily-adhesive layer therein, by using a constant voltage power source [“TR-300C” (trade name), manufactured by Takeda Riken Industry Co., Ltd.], a current meter [“TR-8651” (trade name), manufactured by Takeda Riken Industry Co., Ltd.], and a sample chamber [“TR-42” (trade name), Takeda Riken Industry Co., Ltd.]

The surface electrical resistance (log SR) of the solar cell backsheet in the present invention is preferably 8.5 or more and more preferably 12 or more.

Preparation of Backsheet

The solar cell backsheet of the present invention may be prepared by any method as long as the readily-adhesive layer already mentioned is allowed to be formed on a support. In the present invention, the preparation of the solar cell backsheet may be performed preferably by a method that includes a step (coating step) of applying a coating liquid for readily-adhesive layer on the support. In addition, when the backsheet further includes an undercoat layer, a color layer and others, the coating step may be performed as: a coating liquid for under coat layer, a coating liquid for color layer, and a coating liquid for readily-adhesive layer are applied onto the support successively from the support side, for instance.

Note that, the coating liquid for readily-adhesive layer includes therein a binder and inorganic particles; the amount of the inorganic particles is from 10% by volume to 500% by volume with respect to the total volume of the binder; and the coating liquid is used to form an readily-adhesive layer that exhibits a peeling strength of 25 N/20 mm or more against a sealing material (preferably, an ethylene-vinylacetate copolymer based sealing material). The support and details of the components that are included in respective coating liquids and the ranges of amount thereof are as already described.

A preferable coating method is also as already described, for instance, gravure coating or bar coating may be used.

The coating liquid for readily-adhesive layer is preferably a water-based coating liquid that includes water in a ratio of 60% by mass or more with respect to the total mass of the solvent that is included in the coating liquid for readily-adhesive layer. The water-based coating liquid is preferred from the viewpoint of environmental burden. In addition, a water ratio of 60% by mass or more is advantageous because environmental burden is especially reduced.

A still higher water ratio in the coating liquid for readily-adhesive layer is preferable from the viewpoint of environmental burden. More preferably, water is included in a ratio of 90% by mass or more with respect to the whole solvent of the coating liquid for readily-adhesive layer.

Solar Cell Module

The solar cell backsheet of the present invention may be preferably used as a member that composes a solar cell module.

For instance, the solar cell module may be configured as: solar cell elements that convert light energy of sun light into electrical energy are disposed between a transparent substrate through which sun light enters and the solar cell backsheet of the present invention that has been already described; and a space between the substrate and the backsheet is sealed with a sealing material (preferably, an ethylene-vinylacetate copolymer based sealing material).

Regarding members other than the solar cell module, the solar cells, and the backsheet, they are described in detail in “Taiyoko Hatsuden System Kosei Zairyo” (under the supervision of Eiichi Sugimoto, published by Kogyo Chosakai Publishing, Inc., 2008), for example.

The transparent base board may only has a light transparency to such an extent that sunlight is allowed to pass through it, and may be selected appropriately from base materials that allow light to transmit therethrough. From the viewpoint of power generation efficiency, a transparent base board that has a higher light transmittance is more preferable. For such a transparent base board, a glass base board, a transparent resin such as acrylic resin and the like may be suitably used, for example.

For the solar cell elements, various kinds of known solar cell elements may be used, including: solar cells based on silicon such as single crystal silicon, polycrystalline silicon, or amorphous silicon; and solar cells based on a III-V or II-VI compound semiconductor such as copper-indium-gallium-selenium, copper-indium-selenium, cadmium-tellurium, or gallium-arsenic. This application claims priority from Japanese Patent Application Nos. 2010-70589 filed on Mar. 25, 2010, and 2011-038854 filed on Feb. 24, 2011, the disclosures of which are incorporated by reference herein.

### EXAMPLE

The present invention will be further described in detail with reference to the following examples, but it should be construed that the present invention is in no way limited to those examples as long as not departing from the scope of the invention. Note that, if not otherwise specified particularly, “part(s)” and “%” are on the basis of mass.

Note that, volume average particle size was measured by using a laser diffraction particles size distribution analyzer “LA-950” (manufactured by HORIBA, Ltd.).

### Example 1

Preparation of Support

—Synthesis of Polyester—

Slurry that included 100 kg of high purity terephthalic acid (manufactured by MITSUI CHEMICALS, INC.) and 45 kg of ethylene glycol (manufactured by NIPPON SHOKUBAI CO., LTD.) was fed successively over 4 hours to an esterification tank that was maintained at a temperature of 250° C. and a pressure of 1.2×10⁵ Pa and was preliminary loaded with 123 kg or about 123 kg of bis(hydroxyethyl) terephthalate. After feeding was completed, esterification was still continued for 1 hour. After that, 123 kg of resulting esterification product were transferred to a polycondensation reactor tank.

Then, ethylene glycol in an amount of 0.3% with respect to a polymer to be obtained was added to the polycondensation reactor tank in which the esterification product had been transferred. After 5 minute agitation, an ethylene glycol solution that contained cobalt acetate and another ethylene glycol solution that contained manganese acetate were added in a manner that 30 ppm of cobalt acetate and 15 ppm of manganese acetate with respect to the polymer to be obtained were contained respectively in the resulting reaction mixture. After another 5 minute agitation, an ethylene glycol solution that contained 2% of a titanium alkoxide compound was added in a manner that the content thereof became 5 ppm with respect to the polymer to be obtained. Five minute later, an ethylene glycol solution that contained 10% of dimethylphosphonoethyl acetate was added in a manner that the content thereof became 5 ppm with respect to the polymer to be obtained. After that, the temperature of the reaction system was gradually elevated from 250° C. to 285° C. and the pressure was lowered to 40 Pa while the resulting low molecular weight polymer was agitated at 30 rpm. The time elapsed until the temperature reached a final temperature and the time elapsed until the pressure reached a final pressure, both times were selected to be 60 minutes. At the time when an agitation torque reached a predetermined value, the reaction system was purged with nitrogen gas, so that the pressure was restored to normal pressure and that polycondensation was terminated. Then, by ejecting into cold water in a strand form and immediate cutting out, polymer pellets (about 3 mm diameter and about 7 mm long) were obtained. Note that, the time elapsed from the start of reducing pressure to the time when the agitation torque reached the predetermined value was 3 hours.

Note that, as the titanium alkoxide compound, a titanium alkoxide compound (4.44% by mass of Ti content) synthesized in Example 1 of paragraph number [0083] of JP-A No. 2005-340616 was used.

Preparation of Base

The pellets obtained above were fused at 280° C. and cast on a metal drum to prepare an un-stretched base having about 3 mm thick. Then, stretching by 3.3 times in a longitudinal direction at 90° C.; further stretching by 3.3 times in a transverse direction at 120° C.; 10 minute heat-fixing at 215° C.; and 10 minutes annealing at 210° C. were successively performed. Further, both faces of the resulting film were subjected to corona discharging treatment, so that a polyethylene terephthalate film (PET film, 188 μm thick) with 35 equivalents per ton of carboxyl group content was prepared.

The carboxyl group content in the support was calculated as follows.

The weight w [g] of 0.1 g of the support was measured. The support was put in a round-bottom flask with 5 mL of benzyl alcohol, which was then kept at 205° C. for 24 hours. After that, the content was added to 15 mL of chloroform. A small amount of phenol red indicator was added to the resulting liquid, which was then titrated with a benzyl alcohol solution which contained potassium hydroxide in a concentration of 0.01 N. In accordance with the following equation, in which the amount of the potassium hydroxide solution used for the titration was represented by x [mL], the carboxyl group content (COOH group content) in the support was evaluated.

Carboxyl group content (equivalent per ton)=0.01×x/w

Note that, hereinafter, “equivalent per ton” is represented also as “eq./t.”

Preparation of Readily-Adhesive Layer

On the one side of the resulting polyethylene terephthalate film, a coating liquid for first readily-adhesive layer and a coating liquid for second readily-adhesive layer, which had the following compositions respectively, were applied in this order, so that a solar cell backsheet including two readily-adhesive layers was prepared.

Coating Liquid for First Readily-Adhesive Layer

Binder,

ammonium salt of ethylene-acrylic acid copolymer [Al; “CHEMIPEARL S75N” (trade name), manufactured by Mitsui Chemicals, Inc., 24.5% of solid content]: 2.39%,

Surfactant,

polyoxyalkylene alkyl ether [“NAROACTY CL-95” (trade name), manufactured by Sanyo Chemical Industries, 1% of solid content]: 6.30%,

Cross-linking agent,

oxazoline compound [B1; “EPOCROS WS700” (trade name), manufactured by NIPPON SHOKUBAI CO., LTD., 25% of solid content]: 0.71%,

Inorganic fine particles,

colloidal silica [C1; “SNOWTEX CM” (trade name), manufactured by NISSAN CHEMICAL INDUSTRIES, LTD., 30% of solid content]: 3.07%,

silica fine particles [C2; “AEROSIL OX-50” (trade name), Nippon Aerosil Co., Ltd., 10% of solid content]: 9.21%, and

Distilled water: 78.3%.

The coating liquid for first readily-adhesive layer having the above composition was applied on the one side of the polyethylene terephthalate film and dried at 175° C. for 30 seconds, so that a first readily-adhesive layer (under layer) having a thickness of 0.5 μm was formed.

Coating Liquid for Second Readily-Adhesive Layer

Binder,

acrylic acid ester copolymer [A2; “JURYMER ET-410” (trade name), 30% of solid content]: 2.33%,

Surfactant,

polyoxyalkylene alkyl ether [“NAROACTY CL-95” (trade name), manufactured by Sanyo Chemical Industries, 1% of solid content]: 7.72%,

Cross-linking agent,

epoxy compound [B3; “DECANOL EX-614B” (trade name), manufactured by Nagase ChemteX Corp., 1% of solid content]: 22.2%, and

Distilled water: 67.75%.

The coating liquid for second readily-adhesive layer having the above composition was applied over the first readily-adhesive layer (under layer), dried at 175° C. for 30 seconds so as to form a second readily-adhesive layer (upper layer) having a thickness of 0.2 μm, whereby a solar cell backsheet of Example 1 was prepared.

### Example 2

In the preparation of the support of Example 2, after pellets were prepared substantially similar to that in Example 1, the following solid-phase polymerization was carried out before a base was prepared. After that, an un-stretched base was prepared by using the resulting pellets that had been performed the solid-phase polymerization, and the un-stretched base were subjected to, bi-axial stretching, heat-fixing, and annealing, in substantially the same manner as that in Example 1, whereby a support of Example 2 that had a carboxyl group content as shown in Table 1 was prepared.

Solid-Phase Polymerization

For the polymerized pellets of polyethylene terephthalate, solid-phase polymerization was performed in the following manner (batch process).

After the pellets were charged in a vacuum-resistant vessel, air in the inside of the vessel was evacuated. Then, the pellets were kept at 210° C. for 20 hours while agitated so as to perform solid-phase polymerization.

### Comparative Example 1

Pellets of Comparative Example 1 was prepared in a manner substantially similar to that in Example 1, except that the fusing temperature in the preparation of the pellets of Comparative Example 1 was changed to 310° C. instead of 295° C. in Example 1. Then, an un-stretched base was prepared from the obtained pellets, and the resulting un-stretched base was subjected to bi-axial stretching, heat-fixing, and annealing in a manner substantially similar to that in Example 1, so that a support of Comparative Example 1 having a carboxyl group content as shown in Table 1 was prepared.

### Example 3 to Example 19, and Comparative Example 2 to Comparative Example 5

Solar cell backsheets of Example 3 to Example 19 and Comparative Example 2 to Comparative Example 5 were prepared in a manner substantially similar to that in Example 1, except that the kinds of support, binder, cross-linking agent, and inorganic fine particles, and the addition amounts of inorganic fine particles in the preparation of the solar cell backsheet of Example 1 were changed as shown in Table 1.

Measurement for Elongation at Break of Support

For the supports of solar cell backsheets of Example 1 to Example 19 and Comparative Example 1 to Comparative Example 5, elongation at break of support was measured and a retention ratio of elongation at break (elongation at break of support after wet and heat storage treatment 1/elongation at break of support before wet and heat storage treatment 1) was calculated according to the already described Equation (2). For the calculation of the retention ratio of elongation at break, the elongation of support was measured as follows.

For the supports of Example 1 to Example 19 and Comparative Example 1 to Comparative Example 5, two sheets were prepared respectively. Respective two sheets were cut into 10 mm wide×200 mm long. One of the two sheets was stored in an atmosphere of 120° C. and 100% RH for 50 hours (wet and heat storage treatment 1). The condition of the wet and heat treatment 1 is harder than the 1000 hours of storage at 85° C. and 85% RH (wet and heat storage treatment 2), under which polyester may be hydrolyzed.

A support that had treated with the wet and heat storage treatment 1 and a support (corresponding to a support before wet and heat storage treatment 1) that had not treated with the wet and heat storage treatment 1, each was nipped with 10 cm clips and held therebetween. A strength of 20 mm/minute was applied in a longitudinal direction across both longitudinal ends of each support, so that the support was stretched, whereby elongation at break was measured, and a retention ratio of elongation at break was calculated according to the Equation (2). The results are shown in the following Table 1.

Evaluation of Solar Cell Backsheet

The solar cell backsheets of Example 1 to Example 19 and Comparative Example 1 to Comparative Example 5 were subjected to the following adhesion evaluation and electrical insulation property evaluation. Evaluation results are shown in the following Table 1.

1. Adhesion Evaluation (Peeling Strength Measurement)

A) Adhesion between EVA sealing material and readily-adhesive layer (second readily-adhesive layer)

Sample Preparation

As a sealing material, an EVA sheet [EVA sheet: “SC50B” (trade name), manufactured by Mitsui Chemicals Fabro, Inc.] cut into 20 mm wide×100 mm long was prepared. Then, respective solar cell backsheets of Example 1 to Example 19 and Comparative Example 1 to Comparative Example 5 were cut into 20 mm wide×150 mm long. Two sheets were prepared respectively. The EVA sheet prepared above was sandwiched between these two sheets in a manner that each second readily-adhesive layer (upper layer) faces to the inside, and then they were bonded together by hot-pressing with a vacuum laminator [vacuum lamination machine, manufacture by Nisshinbo Industries, Inc.] In this way, the second readily-adhesive layers (upper layer) of the solar cell backsheets of Example 1 to Example 19 and Comparative Example 1 to Comparative Example 6 and the EVA sheet were bonded together to obtain EVA-bonded sheets respectively. As the condition of bonding the EVA sheet, a bonding treatment at 150° C. for 30 minutes was selected. The bonding treatment was performed one time.

Wet and Heat Storage Treatment 2

The resulting EVA-bonded sheets were stored in an atmosphere of 85° C. and 85% RH for 1,000 hours.

Measurement of Peeling Strength

With “TENSILON” (trade name) (RTC-1210A, manufactured by ORIENTEC Co., Ltd.), un-bonded portions of an EVA-bonded sheet were nipped with upper and lower clips, and the peeling strength between the EVA sealing material and the second readily-adhesive layer was measured at a peeling angle of 180° and a rate of pulling of 300 mm/minute.

The measurement of peeling strength was performed on both samples: a sample before treating with the wet and heat storage treatment 2 (Fresh); and a sample after treated with the wet and heat storage treatment 2 (PC). Adhesion was evaluated in accordance with the following criteria.

Evaluation Criteria

AA: Best bonding (peeling strength was 75 N/20 mm or more),

A: Better boding (peeling strength was 50 N/20 mm or more and less than 75 N/20 mm),

B: Good bonding (peeling strength was 10 N/20 mm or more and less than 50 N/20 mm), and

C: Bad bonding (peeling strength was less than 10 N/20 mm).

Evaluation of electrical insulation properties (surface electrical resistance: log SR)

The surface electrical resistance of solar cell backsheets of Example 1 to Example 19 and Comparative Example 1 to Comparative Example 5 was represented by a value (log SR) that was measured in accordance with resistivity as defined by JIS-K6911-1979. The measurement of surface electrical resistance was performed on a backsheet having a support and an readily-adhesive layer by using a constant voltage power source [“TR-300C” (trade name), manufactured by Takeda Riken Industry Co., Ltd.], a current meter [“TR-8651” (trade name), manufactured by Takeda Riken Industry Co., Ltd.], and a sample chamber [“TR-42” (trade name), Takeda Riken Industry Co., Ltd.].

TABLE 1

| | Support | | | | | 1st RAL | | | | | | 2nd RAL | | | | | | Evn. of BS | | |
|---|---|---|---|---|---|---|---|---|---|---|---|---|---|---|---|---|---|---|---|---|
| | | | | ET | | | | Content of IOFP | | | | | | Content of IOFP | | | | Peel. St. | | Ins. Pro |
| | CC | Cat. | SP | (° C.) | RRE | B | CA | C1 | C2 | C3 | Total | B | CA | C1 | C2 | C3 | Total | Fresh | PC | LogSR |
| 1 | 35 | Ti | non | 280 | 0.6 | A1 | B1 | 73 | 73 | — | 146 | A2 | B3 | — | — | — | — | AA | AA | 12≦ |
| 2 | 15 | Ti | prf. | 280 | 0.9 | A1 | B1 | 73 | 73 | — | 146 | A2 | B3 | — | — | — | — | AA | AA | 12≦ |
| 3 | 35 | Ti | non | 280 | 0.6 | A1 | B1 | 73 | 73 | — | 146 | A2 | B3 | — | — | — | — | AA | AA | 12≦ |
| 4 | 35 | Ti | non | 280 | 0.6 | A1 | B1 | 62 | 62 | — | 123 | A2 | B3 | — | — | — | — | AA | AA | 12≦ |
| 5 | 35 | Ti | non | 280 | 0.6 | A1 | B1 | — | 146 | — | 146 | A2 | B3 | — | — | — | — | AA | AA | 12≦ |
| 6 | 35 | Ti | non | 280 | 0.6 | A1 | B2 | — | 76 | — | 76 | A2 | B3 | — | — | — | — | B | B | 12≦ |
| 7 | 35 | Ti | non | 280 | 0.6 | A2 | B2 | — | 76 | — | 76 | A2 | B3 | — | — | — | — | AA | B | 12≦ |
| 8 | 35 | Ti | non | 280 | 0.6 | A2 | B3 | — | 76 | — | 76 | A2 | B3 | — | — | — | — | AA | B | 12≦ |
| 9 | 35 | Ti | non | 280 | 0.6 | A2 | B4 | — | 78 | — | 78 | A2 | B3 | — | — | — | — | AA | B | 12≦ |
| 10 | 35 | Ti | non | 280 | 0.6 | A1 | B1 | — | — | 76 | 76 | A2 | B3 | — | — | — | — | A | A | 8.5 |
| 11 | 35 | Ti | non | 280 | 0.6 | A1 | B2 | — | — | 76 | 76 | A2 | B3 | — | — | — | — | B | B | 8.5 |
| 12 | 35 | Ti | non | 280 | 0.6 | A2 | B2 | — | — | 76 | 76 | A2 | B3 | — | — | — | — | AA | B | 8.5 |
| 13 | 35 | Ti | non | 280 | 0.6 | A2 | B3 | — | — | 76 | 76 | A2 | B3 | — | — | — | — | AA | B | 8.5 |
| 14 | 35 | Ti | non | 280 | 0.6 | A2 | B4 | — | — | 78 | 78 | A2 | B3 | — | — | — | — | AA | B | 8.5 |
| 15 | 35 | Ti | non | 280 | 0.6 | A1 | B3 | — | — | 76 | 76 | A2 | B3 | — | — | — | — | A-AA | B | 8.5 |
| 16 | 35 | Ti | non | 280 | 0.6 | A3 | B2 | — | — | 76 | 76 | A2 | B3 | — | — | — | — | AA | B | 8.5 |
| 17 | 35 | Ti | non | 280 | 0.6 | A3 | B3 | — | — | 76 | 76 | A2 | B3 | — | — | — | — | B-A | B | 8.5 |
| 18 | 35 | Ti | non | 280 | 0.6 | A3 | B3 | — | — | 76 | 76 | A2 | B3 | — | — | — | — | B-A | B | 8.5 |
| 19 | 35 | Ti | non | 280 | 0.6 | A1 | B1 | 73 | 73 | — | 146 | A2 | B3 | 15 | 15 | — | 30 | AA | AA | 12≦ |
| Comp. | | | | | | | | | | | | | | | | | | | | |
| Exp. | | | | | | | | | | | | | | | | | | | | |
| 1 | 54 | Ti | non | 310 | 0 | A1 | B1 | — | — | — | — | A2 | B3 | — | — | — | — | C | C | 12≦ |
| 2 | 54 | Ti | non | 310 | 0 | A1 | B1 | 73 | 73 | — | 146 | A2 | B3 | — | — | — | — | C | C | 12≦ |
| 3 | 35 | Ti | non | 280 | 0.6 | A1 | B1 | — | — | — | — | A2 | B3 | — | — | — | — | C | C | 12≦ |
| 4 | 35 | Ti | non | 280 | 0.6 | A1 | B1 | 15 | 15 | — | 30 | A2 | B3 | — | — | — | — | C | C | 12≦ |
| 5 | 35 | Ti | non | 280 | 0.6 | A1 | B1 | 250 | 250 | — | 500 | A2 | B3 | — | — | — | — | C | C | 12≦ |

In Table 1, the abbreviation “Comp. Exp.” denotes “Comparative Examples”, the abbreviation “CC” denotes “an amount of carboxylic group contained in the support (polyester) (equivalents per ton)”, the abbreviation “Cat.” denotes “Catalyst”, the abbreviation “SP” denotes “Solid phase polymerization”, the abbreviation “prf.” denotes “performed”, the abbreviation “ET” denotes “Extrusion temperature”, the abbreviation “RRE” denotes “retention ratio of elongation at break”, the abbreviation “B” denotes “Binder”, the abbreviation “CA” denotes “Cross-linking Agents”, the abbreviation “1st RAL” denotes “the first readily-adhesive layer (under layer)”, the abbreviation “IOFP” denotes “Inorganic fine particles (volume % per binder)”, the abbreviation “2nd RAL” denotes “the second readily-adhesive layer (upper layer)”, the abbreviation “Peel. St.” denotes “Peeling Strength (Adhesiveness)”, the abbreviation “Evn.” denotes “Evaluation”, the abbreviation “BS” denotes “Backsheet”, the abbreviation “PC” denotes “after treated with the wet and heat storage treatment 2”, and the abbreviation “Ins. Pro.” denotes “Electrical Insulation Properties”.

The details of Al to A3, B1 to B4, and C1 to C3 in Table 1 are as follows.

Binder

A1: “CHEMIPEARL S75N” (trade name), manufactured by Mitsui Chemicals, Inc.,

A2: “JURYMER ET-410” (trade name), manufactured by TOAGOSEI Co., Ltd., and

A3: “CHEMIPEARL S 120” (trade name), manufactured by Mitsui Chemicals, Inc.

Cross-Linking Agent

B1: “EPOCROS WS700” (trade name), manufactured by NIPPON SHOKUBAI CO., LTD.,

B2: “CARBODILITE V-02-L2” (trade name), manufactured by Nisshinbo Industries, Inc.,

B3: “DECANOL EX-614B” (trade name), manufactured by Nagase ChemteX Corp., and

B4: “BECKAMINE M-3” (trade name), manufactured by DIC Kitanihon Polymer Co., Ltd.

Inorganic Fine Particles

C1: “SNOWTEX CM” (trade name), manufactured by NISSAN CHEMICAL INDUSTRIES, LTD. [colloidal silica (20 nm to 30 nm of average particle size, 30% by mass of solid content)],

C2: “AEROSIL OX-50” (trade name), manufactured by Nippon Aerosil Co., Ltd. [silica (0.3 μm of average particle size, 10% by mass of solid content)], and

C3: “TDL” (trade name), manufactured by Mitsubishi Materials Electronic Chemicals Co., Ltd. [water dispersion liquid of tin-antimony based oxide (100 nm of average particle size, 17% by mass of solid content)].

As is known from Table 1, the solar cell backsheets of Examples are excellent in adhesion between the EVA sealing material and the readily-adhesive layer, and in electrical insulation properties. On the other hand, the solar cell backsheets of Comparative Examples, in which the content of the inorganic fine particles in the readily-adhesive layer is not in a range of from 50% by volume to 200% by volume with respect to the total volume of the binder, were not more excellent than Examples in bonding performance and abrasion property. Furthermore, a backsheet having a high surface electrical resistance value may be obtained by using electrical insulating silica particles as filler.

According to the present invention, a solar cell backsheet that is excellent in term of adhesion to a sealing material in a wet and heat environment may be provided.

The foregoing description of the exemplary embodiments of the present invention has been provided for the purposes of illustration and description. It is not intended to be exhaustive or to limit the invention to the precise forms disclosed. The embodiments were chosen and described in order to best explain the principles of the invention and its practical applications, thereby enabling others skilled in the art to understand the invention for various embodiments and with the various modifications as are suited to the particular use contemplated.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

1. A backsheet for a solar cell, the backsheet being disposed to contact a sealing material on a cell side of a substrate at which solar cell elements are sealed with the sealing material, the backsheet comprising:
a support that satisfies a relationship represented by the following Equation (1); and
a readily-adhesive layer comprising a binder and inorganic fine particles, an amount of the inorganic fine particles being from 50% by volume to 200% by volume with respect to the total volume of the binder, and peeling strength between the sealing material and the readily-adhesive layer exhibiting a value of 10 N/20 mm or more after the solar cell backsheet is stored in an atmosphere of 85° C. and 85% RH for 1,000 hours:
1.0≧(ELBA)/(ELBB)≧0.5 Equation (1)
wherein, in Equation (1), ELBA denotes elongation at break after 50 hours of storage in an atmosphere of 120° C. and 100% RH, and ELBB denotes elongation at break before 50 hours of storage in an atmosphere of 120° C. and 100% RH.

2. The backsheet for a solar cell according to claim 1, wherein the amount of the inorganic fine particles is from 75% by volume to 180% by volume with respect to the total volume of the binder.

3. The backsheet for a solar cell according to claim 1, wherein the volume average particle diameter of the inorganic fine particles is in a range of from 0.02 μm to 2.00 μm.

4. The backsheet for a solar cell according to claim 1, wherein the inorganic fine particles comprise at least one selected from the group consisting of silica, calcium carbonate, magnesium oxide, magnesium carbonate and tin oxide.

5. The backsheet for a solar cell according to claim 1, wherein the support comprises polyester.

6. The backsheet for a solar cell according to claim 5, wherein the polyester comprises polyethylene terephthalate.

7. The backsheet for a solar cell according to claim 5, wherein a content of a carboxyl group in the polyester is 35 equivalents per ton or less.

8. The backsheet for a solar cell according to claim 5, wherein the content of a carboxyl group in the polyester is in a range of 2 equivalents per ton to 35 equivalents per ton.

9. The backsheet for a solar cell according to claim 1, wherein the binder comprises at least one selected from the group consisting of polyolefin, polyester and (meth)acrylic based polymer.

10. The backsheet for a solar cell according to claim 1, wherein the sealing material comprises an ethylene-vinylacetate copolymer-based polymer.

11. The backsheet for a solar cell according to claim 1, wherein the binder comprises a crosslinked structure.

12. The backsheet for a solar cell according to claim 11, wherein the crosslinked structure is formed using an oxazoline-based cross-linking agent.

13. The backsheet for a solar cell according to claim 1, having a surface electrical resistance of from 8.5 to 12.

14. The backsheet for a solar cell according to claim 3 wherein the inorganic fine particles comprise at least one selected from the group consisting of silica, calcium carbonate, magnesium oxide, magnesium carbonate and tin oxide.

15. The backsheet for a solar cell according to claim 14 wherein the support comprises polyester.

16. The backsheet for a solar cell according to claim 15, wherein the polyester comprises polyethylene terephthalate.

17. The backsheet for a solar cell according to claim 16, wherein the binder comprises at least one selected from the group consisting of polyolefin, polyester and (meth)acrylic based polymer.

18. The backsheet for a solar cell according to claim 16, wherein the crosslinked structure is formed using an oxazoline-based cross-linking agent.

19. The backsheet for a solar cell according to claim 16, wherein the binder comprises a crosslinked structure.

20. The backsheet for a solar cell according to claim 19, wherein the crosslinked structure is formed using an oxazoline-based cross-linking agent.

21. The backsheet for a solar cell according to claim 16, having a surface electrical resistance of from 8.5 to 12.

22. The backsheet for a solar cell according to claim 21, wherein the content of carboxyl group in the polyester is in a range of 2 equivalents per ton to 35 equivalents per ton.
